(19) United States
(12) Patent Application Publication
(10) Pub. No.: US 2017/0167657 A1
(43) Pub. Date: Jun. 15, 2017

(54) Adjustable Hanging System and Method

(71) Applicant: Jennifer LeeAnn Wei, Cupertino, CA (US)

(72) Inventor: Jennifer LeeAnn Wei, Cupertino, CA (US)

(21) Appl. No.: 14/963,411

(22) Filed: Dec. 9, 2015

(51) Int. Cl. F16M 13/02; F16B 45/00; A63C 17/01

(52) U.S. Cl. CPC F16M 13/02; A63C 17/017; F16B 45/00

(57) ABSTRACT

An adjustable hanging system comprising a first support portion with a first portion configured to be removably mounted to a fixture and a second portion configured to guide him to hold an article, a second support portion with a first portion configured to be mounted to a fixture and a second portion configured to hold an article, and a spacer configured to connect the first and second support portions at an adjustably selected separation distance. A method of use is also disclosed.

### BACKGROUND

This disclosure relates generally to a storage system, and more particularly to a hanging storage system. A hanging system is generally known as a rack and has features including adjustability. It would be useful to develop/improve how items are stored today.

### SUMMARY

One embodiment described herein is an adjustable hanging system comprising a first support portion with a first portion configured to be removably mounted to a fixture and a second portion configured to guide him to hold an article, a second support portion with a first portion configured to be mounted to a fixture and a second portion configured to hold an article, and a spacer configured to connect the first and second support portions at an adjustably selected separation distance.

Another embodiment described herein is an adjustable hanging system comprising a mounting portion with first and second fixture hooks, configured to be mounted to a fixture, first and second support hooks configured to hold an article, and first and second support hooks configured to be removably connected to the mounting portion at an adjustably selected separation distance.

Yet another embodiment is a method of using an adjustable hanging system, comprising obtaining a first support portion with a first portion configured to be removably mounted to a fixture and a second portion to hold an article, obtaining a second support portion with a first portion configured to be removably mounted to a fixture and a second portion configured to hold an article, obtaining a spacer configured to connect the first and second support portions at an adjustably selected separation distance, and removably mounting the spacer to the first and second support portions.

### BRIEF DESCRIPTION OF THE DRAWINGS

FIG. 1 shows the front view of one embodiment of the system with one spacer.

FIG. 2 shows the front view of one embodiment of the system with two spacers.

FIG. 3 is the side view of a support portion with a ‘U’ shaped hook.

FIG. 4 is another side view of a support portion with a ‘V’ shaped hook and a fastening system.

FIG. 5 shows the front view of one embodiment with a longboard hanging on the hooks by its axle.

FIG. 6 shows the hanging system fixed to a door with an ironing board attached.

FIG. 7 shows the front view of a second embodiment of the hanging system.

FIG. 8 shows the side view of a second embodiment of the hanging system with a fastening system.

FIG. 9 shows the side view of a hook of the second embodiment.

FIG. 10 shows the top view of the notched portion.

FIG. 11 shows the front view of a longboard hanging on the system.

### DETAILED DESCRIPTION

This invention is an adjustable hanging system with hooks that can be removably mounted to a fixture. This is useful as it minimizes the number of storage devices needed and is multi-functional.

As used herein, the term “fixture” means a piece of equipment or furniture that is fixed in position in a building or vehicle.

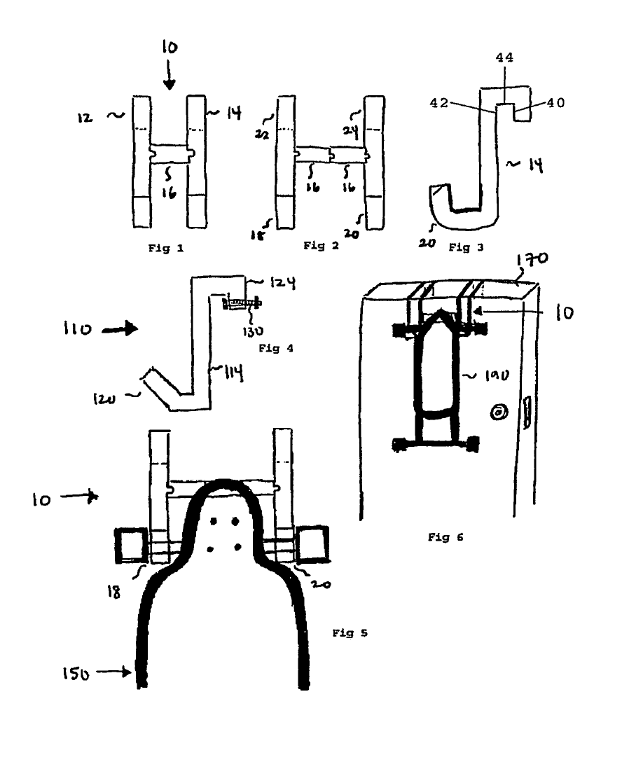

The front view of one embodiment of an adjustable hanging system designated as 10 is shown in FIGS. 1-3, FIG. 1 shows first and second support portions 12, 14 with a single snap-on spacer 16 in between, while FIG. 2 shows an alternative configuration with two snap-on spacers 16. FIG. 2 also shows first and second ‘U’ shaped hooks 18 and 20, respectively, and first and second fixture hooks 22 and 24 that can be removably mounted to a fixture. FIG. 3 shows the side view of the second support portion 14, with the second ‘U’ shaped hook 18 and the second fixed-sized fixture hook 20 that can be removably mounted to a fixture.

In the embodiments, the hooks 18, 20 are typically spaced apart about 0 to about 15 inches, or about 4 to about 12 inches, or about 6 to about 10 inches, with spacers of about ½ inch to about 1 inch in width. In embodiments, the hooks 18, 20 themselves have a height of about 6 to about 15 inches, or about 8 to about 14 inches. In embodiments, the hooks protrude about 2 to 6 inches, or about 3 to 4 inches from the fixture.

FIG. 4 shows an embodiment designated as 110 with a support portion designated as 114. This embodiment has an angled ‘V’ shaped hook 120 and a fixture hook 120 with an adjustable mechanism 130 to secure the system to fixtures of various sizes. The fastening system designated as adjustable mechanism 130 threads through the backside of the fixture hook 120 and can be tightened to secure the system to the fixture it is mounted to. In embodiments, the adjustable mechanism 130 should be able to adjust to attach to fixtures having a thickness of about 1 to about 6 inches, or about 2 to about 5 inches, or about 3 to about 4 inches. This subsystem can also be used with other support portion configurations like that in FIG. 3 and is optional.

As shown in FIG. 5, the hooks 18, 20 support the axles of a board designated as 150. Alternative embodiments may support a board by the wheels. In some cases, embodiment 150 is about 3 inches, or about 2 inches, or about 1 inch wide and deep.

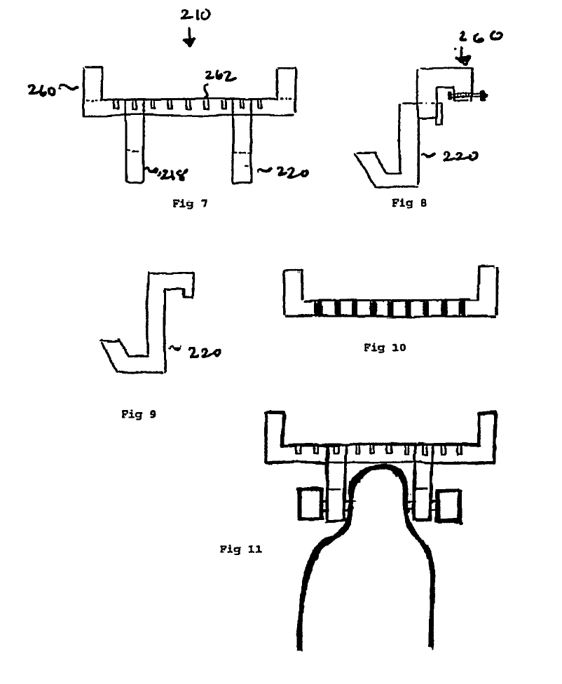

The embodiment in FIG. 6 illustrates the functionality of the hanging system 10, where it is mounted over a door designated as 170 and is shown holding an ironing board designated as 190. In embodiments the door 170 may have a thickness of about 2 inches, or about 1 inch, or about 0.5 inch and a height of about 72 to about 120 inches, or about 80 to about 100 inches.

FIGS. 7-11 show a further embodiment of the adjustable hanging system, designated as 210. FIG. 7 shows the front view of the system with a piece 260 of unitary form that removably mounts to a fixture and two hook attachments 218 and 220 that attach to the unitary piece via notches 262. In embodiments, system 210 has a width of about 8 to about 20 inches, or about 10 to about or 15 inches, and a height of about 1 to about 4 inches, with notch depths of about 0.5 to about 2 inches.

The embodiment in FIGS. 7-11 can be constructed by obtaining a mounting portion comprising first and second hooks configured to be mounted to a fixture, obtaining first and second hooks configured to hold an article, and removably mounting the first and second support hooks to the mounting portion at an adjustably selected separation distance.

FIG. 8 shows the side view of the system with a fastening system 230 similar to that shown in FIG. 5. FIG. 8 shows how the hook (side view shown in FIG. 9) fits into the notch of the unitary piece.

FIG. 10 show a top view of the notching system. The hooks 218 and 220 fit in a tight arrangement into the notches 262, where the top portion of the hook drops through the notch and hooks around the backside of the unitary piece to keep it in place. A reverse configuration alternatively could be used in which, instead of notches, the piece can have extruded portions, and the top portions of the hooks would then have a cut-out that goes through the extruded portion. One configuration for that would be to have a unitary piece with a series of equally spaced out round pins with hooks that each have a hole in their top portion that fit the round pins to have a tight fit.

A number of alternatives, modifications, variations, or improvements therein may be subsequently made by those skilled in the art, which are also intended to be encompassed by the following claims.

1. An adjustable hanging system comprising:
a. a first support portion with a first fixture hook including first and second parallel inner surfaces each having an upper end connected to a perpendicular third inner surface, the first fixture hook being configured to be removably mounted to a door and a second portion configured to hold an article,
b. a second support portion with a first portion configured to be mounted to a door and a second portion configured to hold an article, and
c. at least one snap-on spacer configured to connect to the first and second support portions at an adjustably selected separation distance.

2. The adjustable hanging system of claim 1, wherein the spacer includes first and second pieces configured to be removably connected to one another.

3. The adjustable hanging system of claim 1, wherein the spacer includes a plurality of pieces configured to be removably connected in a row.

4. The adjustable hanging system of claim 1, further comprising a reinforcement component configured to secure the first portions of the first and second support portions to fixtures of various sizes.

5. An adjustable hanging system comprising:
a. a mounting portion comprising first and second fixture hooks configured to be mounted to a fixture,
b. first and second support hooks configured to hold an article, and
c. first and second support hooks configured to be removably connected to the mounting portion at an adjustably selected separation distance.

6. The adjustable hanging system of claim 5, wherein the mounting portion includes a plurality of notches for receiving the first and second support hooks.

7. The adjustable hanging system of claim 5, wherein the mounting portion includes an inverted notch system with pins for receiving the first and second support hooks.

8. The apparatus of claim 5, further comprising a reinforcement component that secures the mounting portion to fixtures of various sizes.

9. A method of using an adjustable hanging system, comprising:
a. obtaining a first support portion with a first portion configured to be removably mounted to a door and a second portion to hold an article,
b. obtaining a second support portion with a first portion configured to be removably mounted to a door and a second portion configured to hold an article,
c. obtaining a spacer configured to connect the first and second support portions at an adjustably selected separation distance, and
d. removably mounting the spacer to the first and second support portions to enforce a selected separation distance between the first and second support portions.

10. The method of claim 9, wherein the step of removably mounting the spacer comprises connecting a plurality of spacers in a row with the first and second support portions.

11. The method of claim 8, further comprising securing the support portions to a fixture with a reinforcement.
